(19) United States
(12) Patent Application Publication
(10) Pub. No.: US 2014/0098998 A1
(43) Pub. Date: Apr. 10, 2014

(54) METHOD AND SYSTEM FOR CONTROLLING OPERATION OF A VEHICLE IN RESPONSE TO AN IMAGE

(71) Applicant: Texas Instruments Incorporated, Dallas, TX (US)

(72) Inventors: Vinay Sharma, Dallas, TX (US); Philip Scott King, Allen, TX (US)

(73) Assignee: Texas Instruments Incorporated, Dallas, TX (US)

(21) Appl. No.: 14/041,696

(22) Filed: Sep. 30, 2013

Related U.S. Application Data
(60) Provisional application No. 61/711,972, filed on Oct. 10, 2012.

(51) Int. Cl. G06K 9/00

(52) U.S. Cl. CPC G06K 9/00375
USPC 382/104

(57) ABSTRACT

For controlling operation of a vehicle, at least one camera captures an image of a screen on which a user places an object having features distinguishing the user. A controller detects the features in the image and analyzes the features to distinguish the user. In response to distinguishing the user, the controller outputs signals for controlling operation of the vehicle. A projector receives information from the controller and projects the information onto the screen, so that the information is displayed on the screen for viewing by the user.

### CROSS-REFERENCE TO RELATED APPLICATION

This application claims priority to U.S. Provisional Patent Application Ser. No. 61/711,972, filed Oct. 10, 2012, entitled METHOD AND APPARATUS FOR BIOMETRICS ON REAR PROJECTION DISPLAYS, naming Vinay Sharma et al. as inventors, which is hereby fully incorporated herein by reference for all purposes.

### BACKGROUND

The disclosures herein relate in general to image processing, and in particular to a method and system for controlling operation of a vehicle in response to an image.

For controlling operation of a vehicle, a conventional fingerprint sensor and a conventional touch pad have electrical components (e.g., electrical metallization), which can increase difficulty and expense of shaping their touched surfaces into various form factors. Also, a conventional fingerprint sensor senses the fingerprint within a relatively small area (e.g., approximately the same size as the fingerprint itself), which is restrictive and potentially inconvenient to the user. By comparison, a conventional touch pad's resolution may be unsuitable for detecting and analyzing particular types of biometric features. Moreover, neither the conventional fingerprint sensor nor the conventional touch pad is suitable for displaying visual information on the touched surface itself for viewing by the vehicle's occupants, which limits a range of direct feedback to such occupants (e.g., type and/or location of requested touch, and/or confirmation of capture). Voice recognition has its own limitations.

### SUMMARY

For controlling operation of a vehicle, at least one camera captures an image of a screen on which a user places an object having features distinguishing the user. A controller detects the features in the image and analyzes the features to distinguish the user. In response to distinguishing the user, the controller outputs signals for controlling operation of the vehicle. A projector receives information from the controller and projects the information onto the screen, so that the information is displayed on the screen for viewing by the user.

### BRIEF DESCRIPTION OF THE DRAWINGS

FIG. 1 is a perspective view of an interior of an automotive vehicle.

FIG. 2 is a block diagram of a console of FIG. 1.

FIG. 3 is a first example image (of an optical touch screen surface of FIGS. 1 and 2) captured and digitized by a camera of FIG. 2.

FIG. 4 is a second example image (of the optical touch screen surface of FIGS. 1 and 2) captured and digitized by the camera of FIG. 2.

FIG. 5 is a modified version of the first example image of FIG. 3.

FIG. 6 is a graph of respective intensities of pixels along a cross-section line of FIG. 5.

FIG. 7 is a modified version of the second example image of FIG. 4.

FIG. 8 is a graph of respective intensities of pixels along a cross-section line of FIG. 7.

FIG. 9 is a flowchart of an operation of the console of FIG. 1.

### DETAILED DESCRIPTION

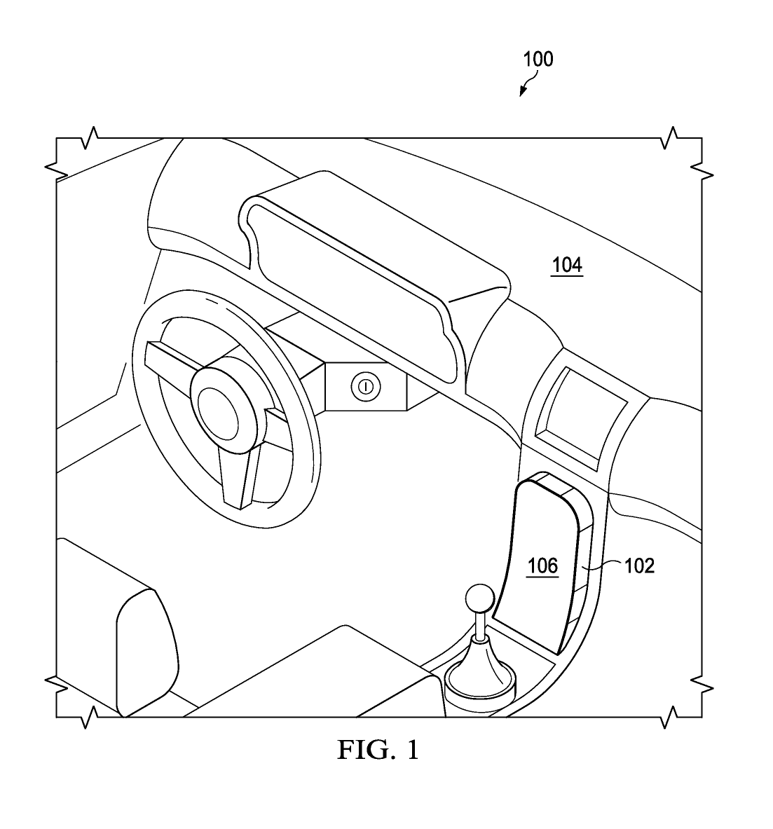

FIG. 1 is a perspective view of an interior, indicated generally at 100, of an automotive vehicle. The interior 100 includes a center console 102, which is installed as a component within a dashboard 104 of the vehicle. The console 102 has an optical touch screen 106 for: (a) displaying visual information to the vehicle's occupants (e.g., driver and/or passenger); (b) receiving commands and other information from one or more of those occupants; and (c) in response to those commands and other information, outputting signals for controlling various operations of the vehicle.

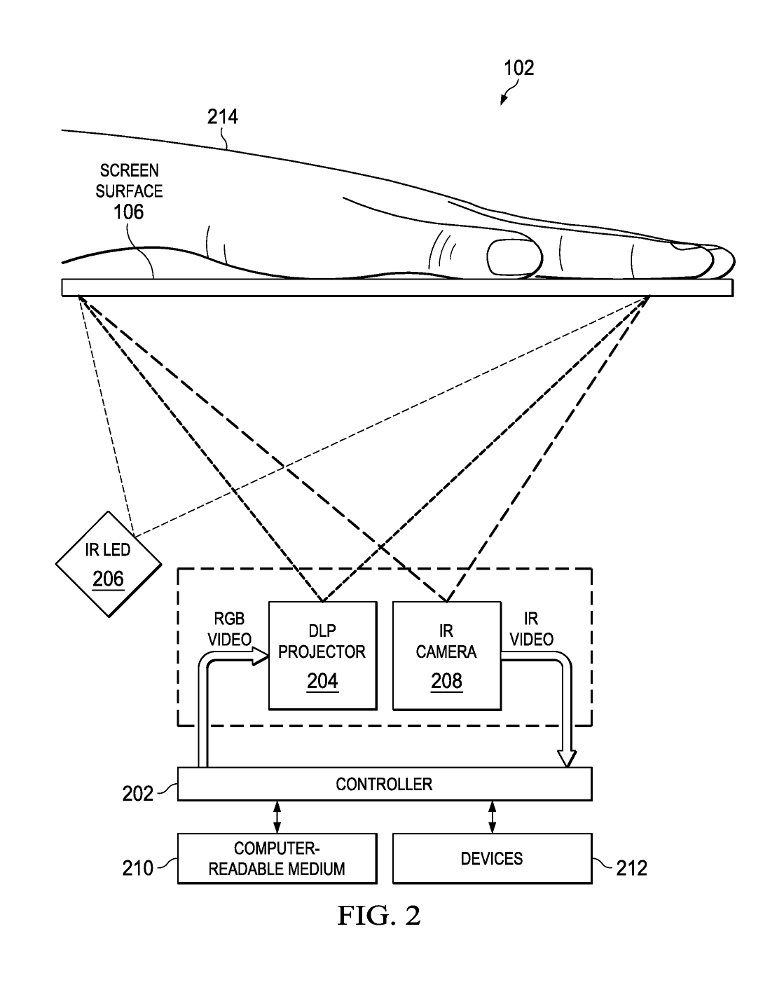

FIG. 2 is a block diagram of the console 102. The console 102 includes a controller 202 (e.g., one or more microprocessors, microcontrollers and/or digital signal processors). The controller 202 is a general purpose computational resource for automatically executing instructions of computer-readable software programs to: (a) process data (e.g., a database of information); and (b) perform additional operations (e.g., communicating information) in response thereto. The controller 202 includes various components (e.g., electronic circuitry components) for performing those operations, implemented in a suitable combination of hardware, firmware and software.

In response to signals from the controller 202, a digital light processing (“DLP”) projector 204 (e.g., rear projector) projects visual information (e.g., RGB video images) onto the screen 106 surface, so that such information is displayed on the screen 106 surface for viewing by the vehicle's occupants. Also, in response to signals from the controller 202, an infrared (“IR”) light-emitting diode (“LED”) 206 projects light for illuminating the screen 106 surface at suitable moments.

Moreover, the console 102 includes at least one camera 208 (capable of detecting IR wavelengths) for viewing the screen 106 surface. For example, in one embodiment, the console 102 includes multiple ones of those cameras for viewing the screen 106 surface from various perspectives (e.g., different angles). While the screen 106 surface is illuminated by the light projected from the LED 206, the camera 208: (a) in response to signals from the controller 202, captures and digitizes images of those views (e.g., a video sequence of images); and (b) outputs those digitized (or “digital”) images to the controller 202. In one embodiment, the projector 204 and the camera 208 are integrated within a single optical module for reducing cost.

The controller 202: (a) receives the digital images from the camera 208; (b) writes those images for storage on a computer-readable medium 210 (which stores the programs, data and other information), such as a nonvolatile storage device and/or a random access memory (“RAM”) device; and (c) performs various operations in response thereto. Those operations include touch processing and user interface (“UI”) interpretation. For example, in response to those images from the camera 208, the controller 202: (a) processes those images to identify commands and other information (represented within those images) from the vehicle's occupants; (b) executes those commands; and (c) writes such other information for storage on the computer-readable medium 210.

Examples of those commands include: (a) commands for the controller 202 to receive information from one or more devices 212 of the vehicle; (b) commands for the controller 202 to project additional visual information (e.g., received from the devices 212) through the projector 204 onto the screen 106 surface, so that such additional visual information is displayed on the screen 106 surface for viewing by the vehicle's occupants; and (c) commands for the controller 202 to control operations of the vehicle by outputting various signals to the devices 212.

In the example of FIG. 2, a hand 214 is placed on the screen 106 surface, so that the controller 202: (a) receives digital images of the hand 214 from the camera 208; (b) writes those images for storage on the computer-readable medium 210; and (c) performs various operations in response thereto. For example, those images of the hand 214 may represent commands and other information from the vehicle's occupants. For clarity, FIG. 2 shows the devices 212 and the hand 214, even though the devices 212 and the hand 214 are not part of the console 102 itself. The console 102 includes other electronic circuitry for performing various additional operations of the console 102.

In that manner, the vehicle's occupants operate the console 102 as an input device for specifying commands and other information (e.g., alphanumeric text information) to the controller 202. For example, one or more of the vehicle's occupants can specify a command and/or other information by touching a portion of a visual image that is then-currently displayed on the screen 106 surface. By automatically receiving and processing images from the camera 208, the controller 202: (a) detects presence and location of a physical touch (e.g., by a finger or hand of such occupant) on the screen 106 surface; and (b) performs various operations in response thereto.

In the illustrative embodiments, the screen 106 is devoid of electrical components (e.g., electrical metallization). For example, the screen 106 is physically distinct from the projector 204, the LED 206 and the camera 208. Accordingly, in comparison to a conventional touchpad or a conventional fingerprint sensor, the screen 106 is easier and less expensive to shape into various form factors, which is helpful in designing and manufacturing the console 102 for installation within the dashboard 104 (FIG. 1) of the vehicle.

Also, pixel resolution of the camera 208 is normally greater than resolution of a conventional touchpad's sensing grid. Accordingly, the console 102 is suitable for detecting and analyzing various types of biometric features (e.g., lengths, widths and ratios of a hand or portion thereof, such as palm lines and fingers) to distinguish the occupants from one another. Moreover, by projecting visual information from the controller 202 through the projector 204 onto the screen 106 surface (for displaying such information on the screen 106 surface itself for viewing by the vehicle's occupants), the console 102 is suitable for displaying a wide range of direct feedback to such occupants (e.g., type and/or location of requested touch, and/or confirmation of capture).

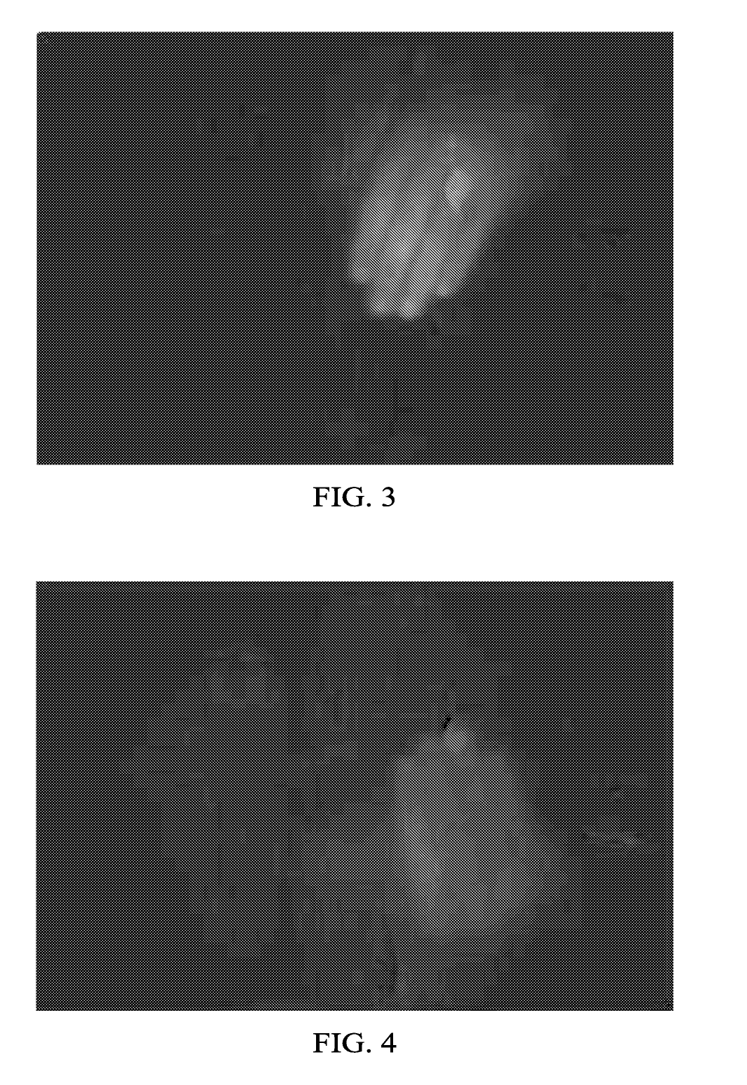

FIG. 3 is a first example image (of the screen 106 surface) captured and digitized by the camera 208. FIG. 4 is a second example image (of the screen 106 surface) captured and digitized by the camera 208. The image of FIG. 3 shows a back of a first occupant's hand, and the image of FIG. 4 shows a back of a second occupant's hand.

The controller 202 receives such images from the camera 208, writes such images for storage on the computer-readable medium 210, processes such images to identify one or more commands from such occupants, and executes such command(s). As shown in FIGS. 3 and 4, the camera 208 is suitable for capturing and digitizing such images of a hand (or portion thereof) anywhere on the screen 106 surface to distinguish the occupants from one another, without restricting the hand's location to a specific portion of the screen 106 surface. However, in one embodiment, the controller 202 projects a visual guide image (e.g., outline of a hand) through the projector 204 onto a specific portion of the screen 106 surface, so that such visual guide image is displayed on the screen 106 surface for viewing by the occupants, and so that the occupants are thereby instructed to place a real hand within such visual guide image on the specific portion of the screen 106 surface.

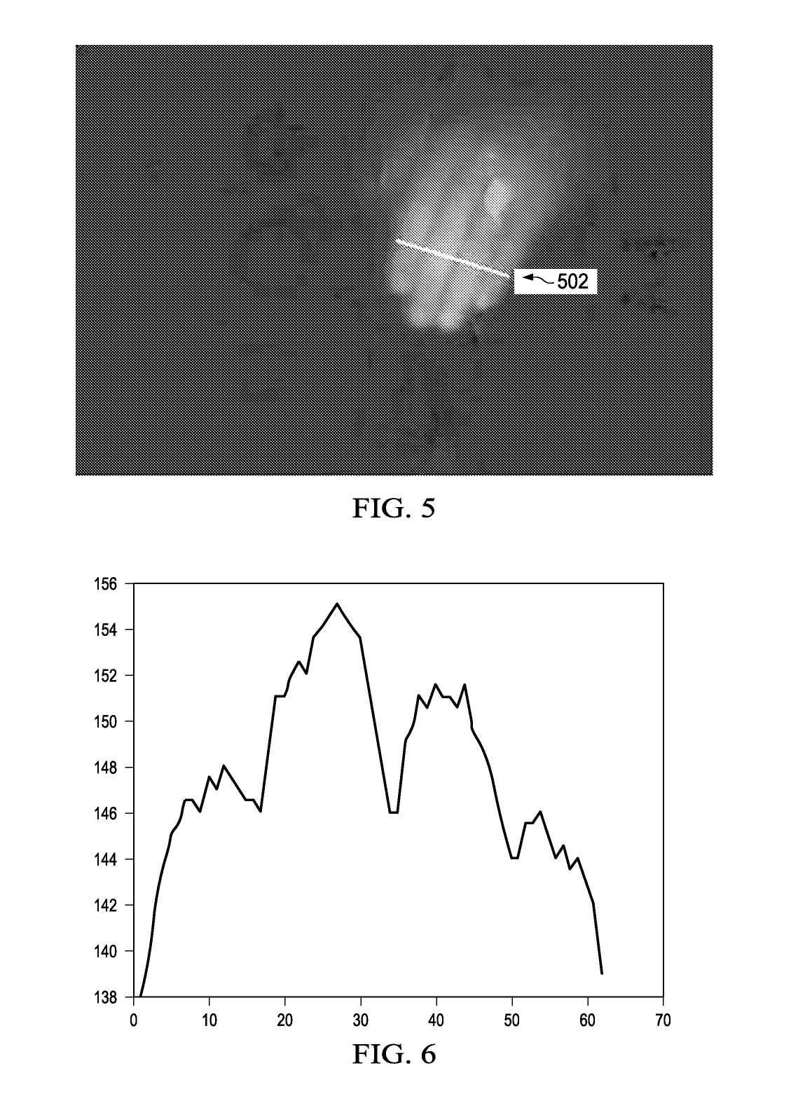

FIG. 5 is a modified version of the first example image of FIG. 3. FIG. 5 shows a cross-section line 502 of fingers that the controller 202 detects in such image. FIG. 6 is a graph of respective intensities of pixels along the cross-section line 502. In response to detecting those fingers in such image, the controller 502 identifies the cross-section line 502 and generates and analyzes a profile of those pixel intensities to distinguish the first occupant's hand from other hands (e.g., distinguish from the second occupant's hand).

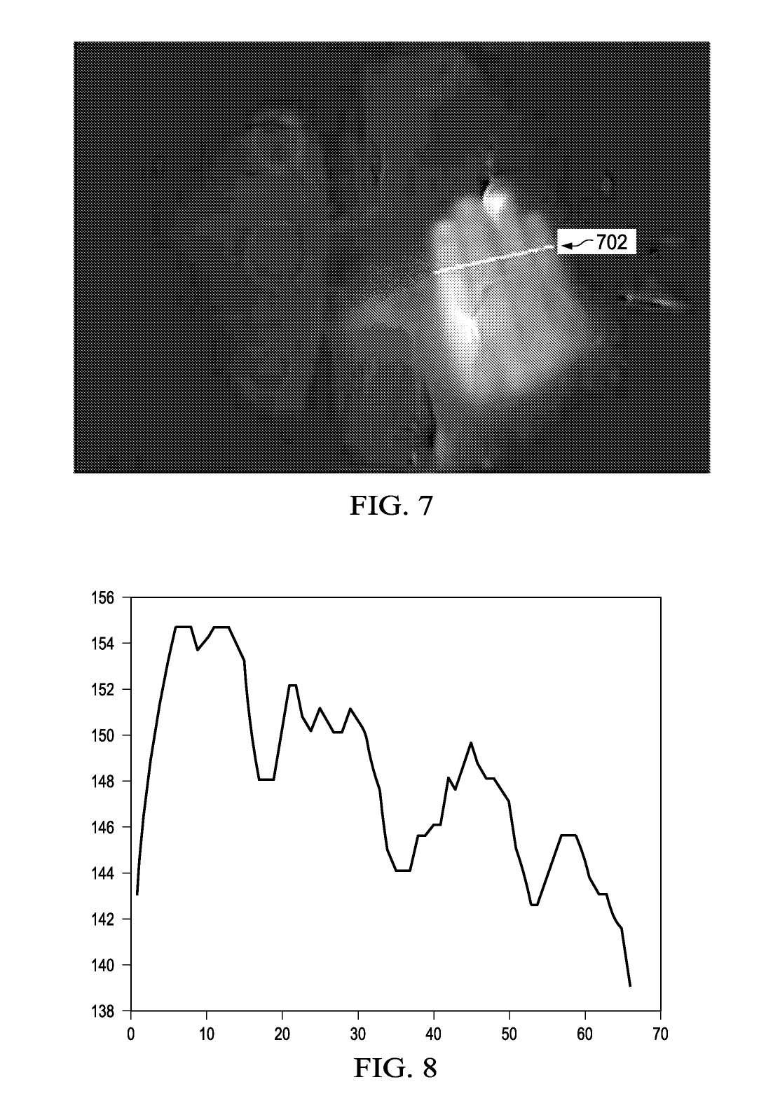

FIG. 7 is a modified version of the second example image of FIG. 4. FIG. 7 shows a cross-section line 702 of fingers that the controller 202 detects in such image. FIG. 8 is a graph of respective intensities of pixels along the cross-section line 702. In response to detecting those fingers in such image, the controller 502 identifies the cross-section line 702 and generates and analyzes a profile of those pixel intensities to distinguish the second occupant's hand from other hands (e.g., distinguish from the first occupant's hand).

In one embodiment, the controller 202 performs computer vision and machine learning operations to identify (e.g., extract) respective sets of relevant biometric features (in captured images received by the controller 202 from the camera 208) that are most effective in distinguishing the occupants from one another. Accordingly, in response to those images, the controller 202 detects and analyzes those identified biometric features to distinguish the occupants from one another. In one example of the illustrative embodiments, those features (e.g., lengths, widths and ratios of hands, palm lines and fingers) are coarser than fingerprints.

Also, the controller 202 distinguishes the occupants from one another by detecting and analyzing other types of features (in captured images received by the controller 202 from the camera 208) that distinguish the occupants from one another. In a first example, those other types of features include biometric features of different body parts (e.g., faces), instead of (or in addition to) hands. In a second example, those other types of features include non-biometric features of an object (e.g., business card or employee badge) that is associated with a particular occupant. In the second example, the particular occupant places such object on the screen 106 surface, and the controller 202 detects and analyzes such object's features (in captured images received by the controller 202 from the camera 208) to distinguish the particular occupant (e.g., distinguish from other potential occupants of the vehicle).

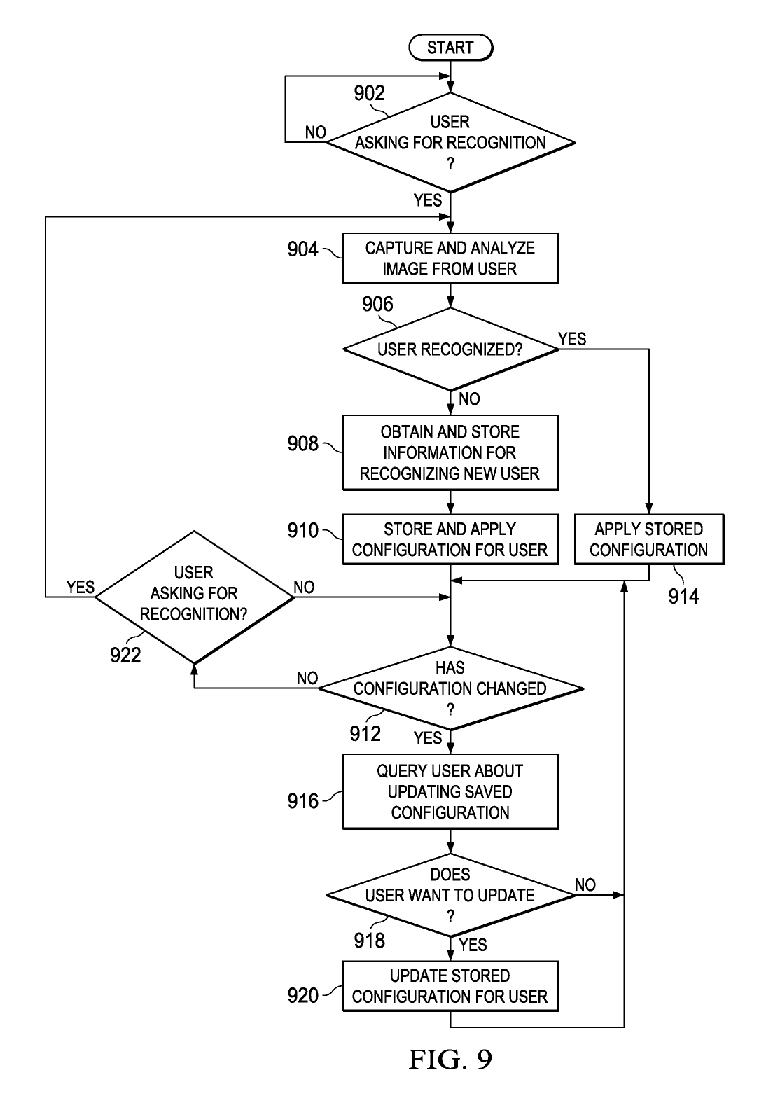

FIG. 9 is a flowchart of an operation of the console 102, which the console 102 performs automatically. At a step 902, the operation self-loops (e.g., in response to the vehicle's ignition being turned on) until the console 102 determines that a user (e.g., vehicle occupant) is asking for recognition. For example, in the illustrative embodiments, the user may ask for recognition by simply placing an object (having features distinguishing the user, such as his or her hand or other body part or object associated with the user) on the screen 106 surface for a prescribed duration of time, and the console 102 automatically detects such placement.

In response to the console 102 determining that the user is asking for recognition, the operation continues from the step 902 to a step 904. At the step 904, the console 102: (a) captures an image of the screen 106 surface; and (b) detects and analyzes features (e.g., biometric features) in the captured image to distinguish the user from other users (e.g., from among a limited group of 10 distinguishable human users). At a next step 906, the console 102 determines whether the step 904 was successful in distinguishing the user from other users.

In response to the console 102 determining that the step 904 was unsuccessful in distinguishing the user from other users (e.g., if the user has never previously occupied the vehicle), the operation continues from the step 906 to a step 908. At the step 908, the console 102 obtains and stores (e.g., in the computer-readable medium 210) information for distinguishing the user as a new user, so that the console 102 thereby registers the new user. For example, in registering the new user at the step 908, the console 102: (a) requires the new user to provide his or her name and other personal information (e.g., age) to the console 102, such as by requiring the new user to touch alphanumeric characters (projected from the controller 202 through the projector 204 onto the screen 106 surface), in a sequence that is viewed by the camera 208, so that the controller 202 receives and stores captured images thereof from the camera 208; and (b) requires the new user to place his or her hand on the screen 106 surface in various poses, so that the controller 202 receives and stores captured images thereof from the camera 208.

At the step 908, the controller 202 analyzes those images to identify (e.g., extract) the new user's respective set of relevant biometric features (e.g., from the new user's hand) that are most effective in distinguishing the new user from other users. Subsequently (e.g., at the step 904), the console 102 distinguishes the new user from other users, according to a technique that discriminates the new user's respective set of relevant biometric features from other users' respective sets of relevant biometric features. In a first embodiment, the console 102 performs this discrimination according to a predefined set of rules.

In a second embodiment, the console 102 performs this discrimination with an n-way classifier, so that: (a) at the step 908, the console 102 generates and trains the n-way classifier according to a machine learning technique, where n is a total number of then-current registered users (e.g., a limited group of n=10 users); and (b) subsequently (e.g., at the step 904), the console 102 applies the n-way classifier to classify detected features in the captured image as belonging to a particular user's respective set of relevant biometric features (from among the n users' respective sets of relevant biometric features). A support vector machine (“SVM”) is one example of the machine learning technique.

After the step 908, the operation continues to a step 910. At the step 910, the console 102 stores (e.g., in the computer-readable medium 210) and applies a respective (user-specific) configuration for the new user, so that the console 102 (via the controller 202) outputs various signals to the devices 212 for controlling operation of the vehicle according to such configuration, including signals for implementing the new user's respective settings of the devices 212. For example, such configuration includes: (a) the new user's customized settings of one or more of the devices 212 (e.g., side view mirror orientation, seat incline angle, steering wheel height, audio volume, music playlist, temperature); and (b) the console 102 default settings of one or more of the devices 212 (e.g., stereo balance, screen 106 brightness level) that the new user has not yet customized. After the step 910, the operation continues to a step 912.

Referring again to the steps 904 and 906, in response to the console 102 determining that the step 904 was successful in distinguishing the user (“recognized user”) from other users (e.g., if the user has previously occupied the vehicle for the console 102 to perform the steps 908 and 910), the operation continues from the step 906 to a step 914. At the step 914, the console 102 reads and applies the previously stored (e.g., step 910) respective configuration for the recognized user. For example, in applying such configuration for the recognized user, the console 102 (via the controller 202) outputs various signals to the devices 212 for controlling operation of the vehicle according to such configuration, including signals for restoring the recognized user's respective settings of the devices 212 (e.g., side view mirror orientation, seat incline angle, steering wheel height, audio volume, music playlist, temperature, stereo balance, or screen 106 brightness level). After the step 914, the operation continues to the step 912.

At the step 912, the console 102 determines whether the vehicle's configuration has changed (compared to the most recently applied settings of the devices 212 by the console 102). For example, in response to a setting (e.g., side view mirror orientation, seat incline angle, steering wheel height, audio volume, music playlist, temperature, stereo balance, or screen 106 brightness level) being adjusted (e.g., by one of the vehicle's occupants), the devices 212 output signals to notify the controller 202 about such adjustment. In response to the console 102 determining that the vehicle's configuration has changed, the operation continues from the step 912 to a step 916.

At the step 916, the console 102 projects a suitable query image onto the screen 106 surface to ask whether the user's respective configuration should be updated to incorporate such change in the vehicle's configuration. For example, if the user wants to adjust the side view mirror orientation, then: (a) the user may perform such adjustment in a conventional manner; (b) in response to such adjustment, the devices 212 output signals to notify the controller 202 about such adjustment; and (c) in response to those signals, the console 102 performs the step 916. In the illustrative embodiments, the suitable query image includes a description of such adjustment, a “Yes” box (or equivalent), and a “No” box (or equivalent).

At a next step 918, the console 102 determines whether the user wants to update his or her respective configuration to incorporate such change in the vehicle's configuration. By reviewing the suitable query image, including its description of such adjustment, the user may clearly understand how his or her respective configuration would be: (a) updated if the user touches the “Yes” box for answering the query; or (b) unchanged if the user touches the “No” box for answering the query. In response to the user's physical touch of the “No” box on the screen 106 surface, the console 102 detects presence and location of such physical touch, and the operation returns from the step 918 to the step 912.

Conversely, in response to the user's physical touch of the “Yes” box on the screen 106 surface, the console 102 detects presence and location of such physical touch, and the operation continues from the step 918 to a step 920. At the step 920, the console 102 updates and stores (e.g., in the computer-readable medium 210) the user's respective configuration to incorporate such change in the vehicle's configuration. After the step 920, the operation returns to the step 912.

In response to the console 102 determining (at the step 912) that the vehicle's configuration is unchanged (compared to the most recently applied settings of the devices 212 by the console 102), the operation continues from the step 912 to a step 922. At the step 922, the console 102 again determines whether a user (e.g., different occupant of the vehicle) is asking for recognition. In response to the console 102 determining that a user is not asking for recognition, the operation returns from the step 922 to the step 912. Conversely, in response to the console 102 determining that a user is asking for recognition, the operation returns from the step 922 to the step 904.

In one embodiment: (a) in response to the user touching the screen 106 surface in a defined way at the step 908 (or at the step 904), and/or in response to the user being at least a minimum age (e.g., according to personal information received by the console 102 at the step 908), the user's respective configuration includes a setting that causes the console 102 (via the controller 202) to output various signals to the devices 212 for enabling the vehicle's movement from a parked position; and (b) otherwise, the user's respective configuration includes a setting that causes the console 102 (via the controller 202) to output various signals to the devices 212 for disabling the vehicle's movement from the parked position. In one example, the defined way requires the user to touch numbers (projected from the controller 202 through the projector 204 onto the screen 106 surface) in a certain passcode sequence. In that manner, the console 102 ensures that only a certain type of recognized user (e.g., vehicle's owner, and/or other adult occupant, who knows the certain passcode sequence) is allowed to enable the vehicle's movement from the parked position.

In the illustrative embodiments, a computer program product is an article of manufacture that has: (a) a computer-readable medium; and (b) a computer-readable program that is stored on such medium. Such program is processable by an instruction execution apparatus (e.g., system or device) for causing the apparatus to perform various operations discussed hereinabove (e.g., discussed in connection with a block diagram). For example, in response to processing (e.g., executing) such program's instructions, the apparatus (e.g., programmable information handling system) performs various operations discussed hereinabove. Accordingly, such operations are computer-implemented.

Such program (e.g., software, firmware, and/or microcode) is written in one or more programming languages, such as: an object-oriented programming language (e.g., C++); a procedural programming language (e.g., C); and/or any suitable combination thereof. In a first example, the computer-readable medium is a computer-readable storage medium. In a second example, the computer-readable medium is a computer-readable signal medium.

A computer-readable storage medium includes any system, device and/or other non-transitory tangible apparatus (e.g., electronic, magnetic, optical, electromagnetic, infrared, semiconductor, and/or any suitable combination thereof) that is suitable for storing a program, so that such program is processable by an instruction execution apparatus for causing the apparatus to perform various operations discussed hereinabove. Examples of a computer-readable storage medium include, but are not limited to: an electrical connection having one or more wires; a portable computer diskette; a hard disk; a random access memory (“RAM”); a read-only memory (“ROM”); an erasable programmable read-only memory (“EPROM” or flash memory); an optical fiber; a portable compact disc read-only memory (“CD-ROM”); an optical storage device; a magnetic storage device; and/or any suitable combination thereof.

A computer-readable signal medium includes any computer-readable medium (other than a computer-readable storage medium) that is suitable for communicating (e.g., propagating or transmitting) a program, so that such program is processable by an instruction execution apparatus for causing the apparatus to perform various operations discussed hereinabove. In one example, a computer-readable signal medium includes a data signal having computer-readable program code embodied therein (e.g., in baseband or as part of a carrier wave), which is communicated (e.g., electronically, electromagnetically, and/or optically) via wireline, wireless, optical fiber cable, and/or any suitable combination thereof.

Although illustrative embodiments have been shown and described by way of example, a wide range of alternative embodiments is possible within the scope of the foregoing disclosure.

What is claimed is:

1. A system for controlling operation of a vehicle, the system comprising:
at least one camera for capturing an image of a screen on which a user places an object having features distinguishing the user;
a controller coupled to the camera for: outputting information; receiving the image from the camera; detecting the features in the image; analyzing the features to distinguish the user; and, in response to distinguishing the user, outputting signals for controlling operation of the vehicle; and
a projector coupled to the controller for: receiving the information from the controller; and projecting the information onto the screen, so that the information is displayed on the screen for viewing by the user.

2. The system of claim 1, wherein the projector is a digital light processing projector.

3. The system of claim 1, wherein the screen is an optical touch screen.

4. The system of claim 3, wherein the screen is devoid of electrical components.

5. The system of claim 1, wherein the screen, the camera and the projector are components of the vehicle.

6. The system of claim 1, wherein the object is a body part of the user.

7. The system of claim 6, wherein the body part is a hand.

8. The system of claim 6, wherein the features are biometric features.

9. The system of claim 1, wherein the signals are for controlling operation of the vehicle according to a configuration that is customized for the user.

10. The system of claim 1, wherein the information includes at least one of: an instruction to the user about placing the object on the screen; and feedback to the user about placing the object on the screen.

11. A method for controlling operation of a vehicle, the method comprising:
with at least one camera, capturing an image of a screen on which a user places an object having features distinguishing the user;
detecting the features in the image;
analyzing the features to distinguish the user;
in response to distinguishing the user, outputting signals for controlling operation of the vehicle; and
with a projector, projecting information onto the screen, so that the information is displayed on the screen for viewing by the user.

12. The method of claim 11, wherein the projector is a digital light processing projector.

13. The method of claim 11, wherein the screen is an optical touch screen.

14. The method of claim 13, wherein the screen is devoid of electrical components.

15. The method of claim 11, wherein the screen, the camera and the projector are components of the vehicle.

16. The method of claim 11, wherein the object is a body part of the user.

17. The method of claim 16, wherein the body part is a hand.

18. The method of claim 16, wherein the features are biometric features.

19. The method of claim 11, wherein the signals are for controlling operation of the vehicle according to a configuration that is customized for the user.

20. The method of claim 11, wherein the information includes at least one of: an instruction to the user about placing the object on the screen; and feedback to the user about placing the object on the screen.

21. A system for controlling operation of a vehicle, the system comprising:
at least one camera for capturing an image of a screen on which a user places an object having biometric features distinguishing the user, wherein the screen is an optical touch screen, and wherein the object is a body part of the user;
a controller coupled to the camera for: outputting information; receiving the image from the camera; detecting the biometric features in the image; analyzing the biometric features to distinguish the user; and, in response to distinguishing the user, outputting signals for controlling operation of the vehicle according to a configuration that is customized for the user; and
a digital light processing projector coupled to the controller for: receiving the information from the controller; and projecting the information onto the screen, so that the information is displayed on the screen for viewing by the user;
wherein the optical touch screen, the camera, the controller and the digital light processing projector are components of the vehicle.

22. The system of claim 21, wherein the screen is devoid of electrical components.

23. The system of claim 21, wherein the body part is a hand.

24. The system of claim 21, wherein the information includes at least one of: an instruction to the user about placing the object on the screen; and feedback to the user about placing the object on the screen.
